(19) United States
(12) Patent Application Publication
(10) Pub. No.: US 2005/0066911 A1
(43) Pub. Date: Mar. 31, 2005

(54) Squeaking dog toy

(76) Inventor: Amy Lubeck, Oregon, WI (US)

Correspondence Address: Peter N. Jansson;Jansson, Shupe & Munger, Ltd., 245 Main Street, Racine, WI, 53403, US

(21) Appl. No.: 10/955,848

(22) Filed: Sep. 29, 2004

Related U.S. Application Data
(60) Provisional application No. 60/507,198, filed on Sep. 29, 2003.
(60) Provisional application No. 60/507,199, filed on Sep. 29, 2003.

(51) Int. Cl. A01K 29/00; A63H 3/06

(52) U.S. Cl. 119/709; 446/183

(57) ABSTRACT

Squeaking dog toys, some of a type including a rope and others not including a rope, include a biting object with an interior cavity and a tough tennis-ball-like outer surface, the biting object having at least one squeaker device within the cavity. The squeaker device within the cavity is either flush-mounted at the outer surface of the biting object or is entirely enclosed therein. Some embodiments are tug toys in which a rope is secured to the biting object. The biting object preferably has a tennis-ball-like outer surface and is most preferably a tennis ball.

### RELATED APPLICATIONS

This application is based in part on U.S. Provisional Application No. 60/507,198, filed Sep. 29, 2003, the contents of which are incorporated herein by reference, and on U.S. Provisional Application No. 60/507,199, filed Sep. 29, 2003, the contents of which are incorporated herein by reference.

### FIELD OF THE INVENTION

This invention relates in general to toys for pets and, more particularly, to dog toys of the type having squeaking devices.

### BACKGROUND OF THE INVENTION

Dog toys provide a means for enjoyment and exercise for dogs (and other pets). As is well known, balls and other pet toys which can bounce and be pounced on and grabbed and pulled by pets mouth are very popular. Dogs love chasing and retrieving such bouncing toys and tugging against the opposite pulling of their owners. While conventional toys of this type are enjoyed by dogs, after a period of play time dogs may lose interest in a toy before their owners do; many dog owners have experienced a sudden abandonment of interest by their dogs in such situations.

Dog toys which include squeaking devices provide a different or additional source of attraction for dogs. Currently, there are variety of toys which are or include squeaking devices. That is, they are or have attached thereto air-containing resilient compressible bladders which have orifices that produce squeaking sounds when air is rapidly emitted upon compression of the resilient compressible air-containing bladders. The air-containing bladders in some cases are themselves balls which may be thrown by dog owners and retrieved by dogs. However, these balls and other such squeaking toys have problems which limit their usefulness. A principal problem is that such squeaking devices are very delicate and are easily punctured by dogs' teeth when bitten, and thus quickly destroyed. Another problem is that squeaking dog toys do not provide the advantage of allowing a tugging action between dog and owner.

Accordingly, there is a need in an improved dog toy which maintains a dog's interest over an extended play period, which can be bitten or chewed by a dog for many days and months without being damaged and destroyed, and which provides a combination of tugging and squeaking entertainment for dogs and their owners. The present invention is a result of research and development concerning the above problems and ways to overcome such problems.

### OBJECTS OF THE INVENTION

It is an object of the invention to provide improved dog toys overcoming problems and shortcomings of the prior dog toys, including those referred to above.

Another object of the invention is to provide a dog toy that extends the period of a dog's interest during play times.

Another object of the invention is to provide improved squeaking dog toys.

Another object of this invention is to provide squeaking dog toys which are highly resistant to damage from biting by dogs.

Another object of this invention is to provide a dog tug toy which, in addition to providing the entertainment of tugging, provides the added attraction of squeaking.

How these and other objects are accomplished will become apparent from the following descriptions and the drawings.

### SUMMARY OF THE INVENTION

This invention, which will be described in detail below, is an improvement in dog toys of the type having a ball or other biting object for dogs to bite. The present invention overcomes the problems described above.

One aspect of this invention is a dog tug toy including a biting object having a hollow interior cavity and a tough outer surface defining at least one rope opening into the cavity; at least one squeaker device within the cavity; and a rope having a first end portion extending into the cavity through the rope opening. In some cases, the squeaker device is entirely enclosed within the cavity. In some preferred embodiments, there are two squeaker devices inside the cavity. The biting object preferably has a tennis-ball-like outer surface, and is most preferably a tennis ball. Throughout this summary section and elsewhere in this specification, this invention will refer to the biting object as a “ball” or “tennis ball”; however, it is to be understood that the invention is not limited in scope by the exact nature of the biting object.

In certain preferred embodiments of the type including a rope attached to the ball or other biting object, the rope includes a second end portion that forms a handle in the form of a loop. In certain embodiments of this type, an additional ball is secured on the loop of the handle. In some cases that include a loop for a handle, the rope has a mid-portion between the first and second end portions and the mid-portion has an additional ball secured thereto. In highly preferred embodiments of this type, there is at least one squeaker device in each of the additional balls.

Another aspect of the invention is a dog toy including a tennis-ball-like ball, preferably a tennis ball, having a hollow interior cavity and a tough outer surface, and at least one squeaker device within the cavity. In some cases, the squeaker device includes or is a squeaker tube having a distal end substantially flush with the outer surface of the ball, while in other cases the squeaker device is entirely enclosed within the cavity. In certain preferred embodiments, the ball has two squeaker devices inside the cavity.

Yet another aspect of this invention involves a resilient body having a hollow interior cavity and a tough outer tennis-ball-like surface, and at least one squeaker device within the cavity.

As used herein, the term “tennis-ball-like ball” includes not only tennis balls, but any hollow ball or bounceable body that is made of a tough rubber or rubber-like material having an felt or felt-like cover. Such balls and bodies are known to be able to withstand repetitive biting by dogs without incurring significant damage. Likewise, the term “tennis-ball-like” refers to the nature of such material. In addition to its toughness, such material is both compressible and resilient; i.e., it quickly returns to its original shape when no longer in the grip of a dog's mouth. Such toys can function months or longer despite considerable abuse by dogs.

As used herein, the term “tough outer surface” means that the material forming the ball or other biting object has a toughness character sufficient such that repetitive frequent biting by a typical dog over an extended period (a month or more) will not puncture the ball or other biting object. Toughness typical of a tennis ball more than satisfies this requirement.

### BRIEF DESCRIPTION OF THE DRAWINGS

FIG. 1 is a perspective view of a dog tug toy in accordance with a preferred embodiment of the invention.

FIG. 1A is a perspective view of the FIG. 1 with the ball in section, including a squeaker device in the ball along with an interior double knot, which has been formed in a particular way as described herein.

FIG. 2 is a perspective view of another embodiment of the invention, this one including two rope openings into the ball with the rope passing through the ball and an exterior knot.

FIG. 2A is a perspective view of the embodiment FIG. 2 with the ball in section, showing two squeaker devices in the ball.

FIG. 3 is a top view of a tennis-ball-like dog ball toy in accordance with a preferred embodiment of the invention including a squeaker tube flush with the outer surface of the ball.

FIG. 3A is a front sectional view of the dog tug toy of FIG. 3.

FIG. 4 is a perspective view of a squeaker tube of the device of FIGS. 3 and 3A.

FIG. 4A is a top view of FIG. 3.

FIG. 5 is a sectional view of a squeaker device with its tube portion shown not in section.

FIG. 5A is a perspective view of squeaker device of FIG. 5 in squeezed folded form.

FIG. 6 is a sectional front view of a tennis-ball-like dog ball toy having a squeaker device entirely enclosed within the ball and shown not in section.

FIG. 7 is a perspective view of an alternative embodiment of the squeaker dog tug toy of this invention having a second ball attached to a second end of the rope.

FIG. 8 is a perspective view of another embodiment having a second ball secured on the rope between the first ball and a handle loop.

FIG. 9 is a perspective view of another embodiment having a second ball on a handle loop.

FIGS. 10A-10H illustrate a method for manufacture of the inventive squeaking dog tug toy of FIG. 1, including the formation of a complex knot within the ball cavity.

FIGS. 11A-11D illustrate another method for manufacture of the inventive squeaking dog tug toy of FIG. 1, including the formation of a complex of knots within the ball cavity.

### DETAILED DESCRIPTION OF PREFERRED EMBODIMENTS

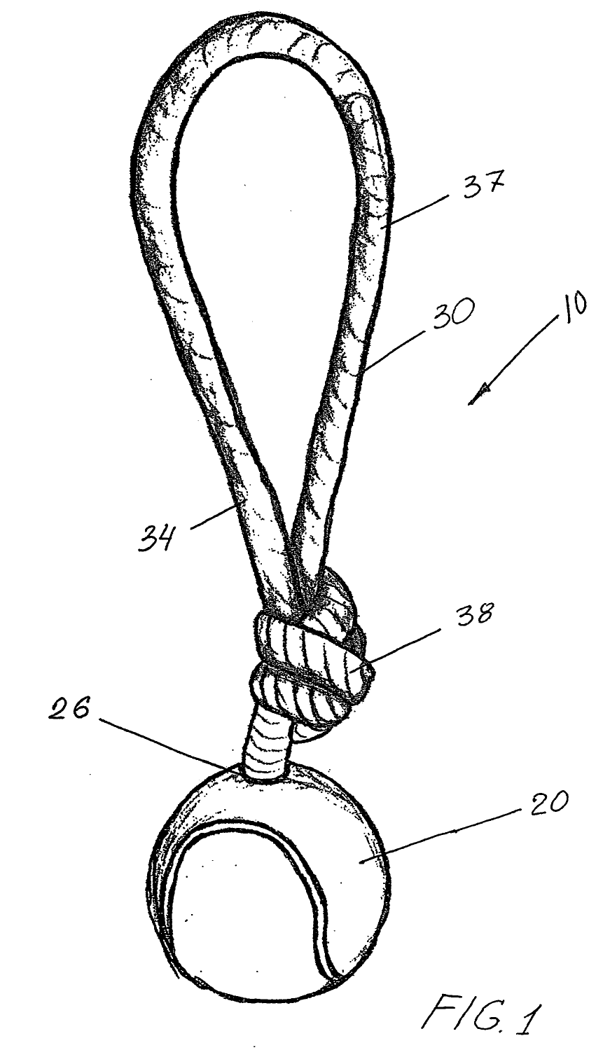

Referring to FIGS. 1 and 1A, a unique dog tug toy 10 is illustrated. Dog tug toy 10 includes a tennis ball 20 and a rope 30. Tennis ball 20 has a hollow interior cavity 22 and a tough felt outer surface 24 defining a rope opening 26. Rope 30 has a first end portion 32 by which it is attached to ball 20, as hereafter described, and a second end portion 34 which forms a loop 37 by tying of loop-forming knot 38. A squeaker device 40 is inserted into hollow interior cavity 22 of ball 20, and a complex of knots, which can be in a form of a double knot 35 or a complex of knots 39, formed in cavity 22 in first end portion 32 of rope 30 to hold rope 30 and ball 20 in reliable connection to each other.

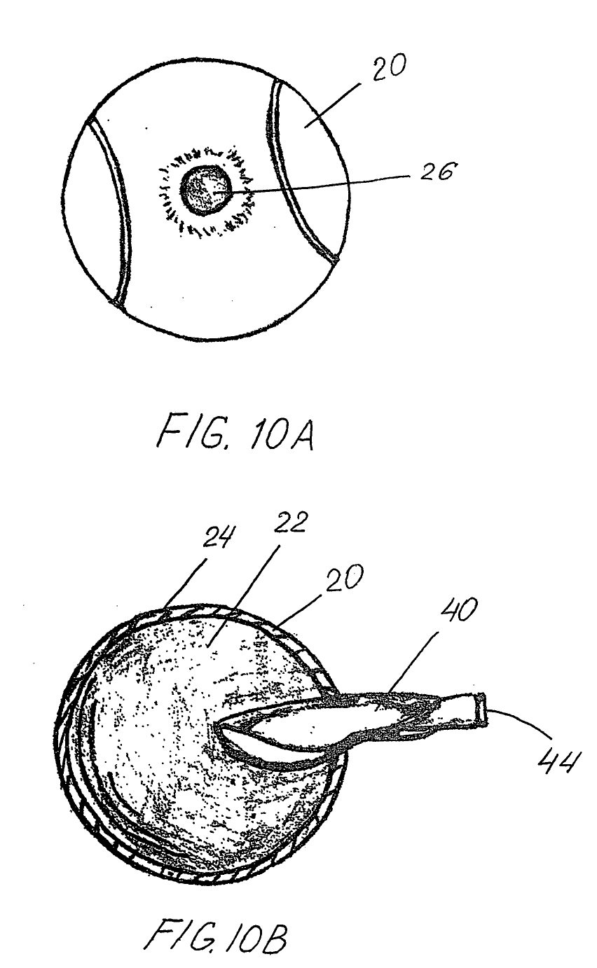

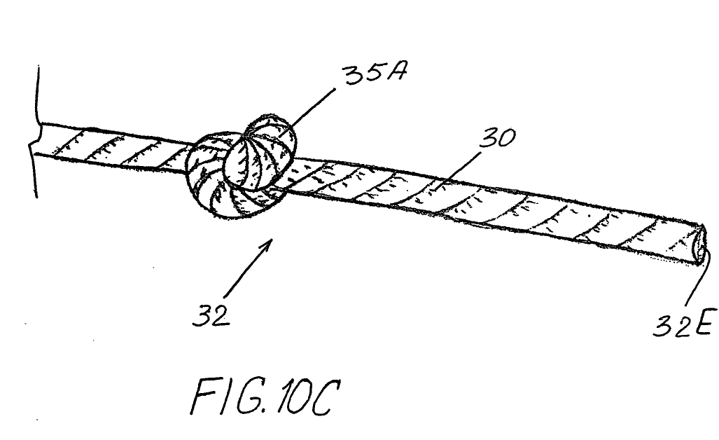

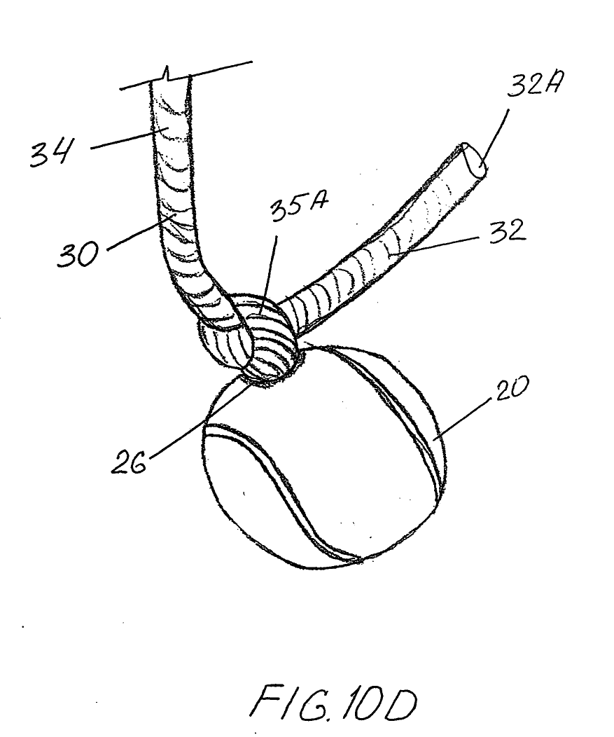

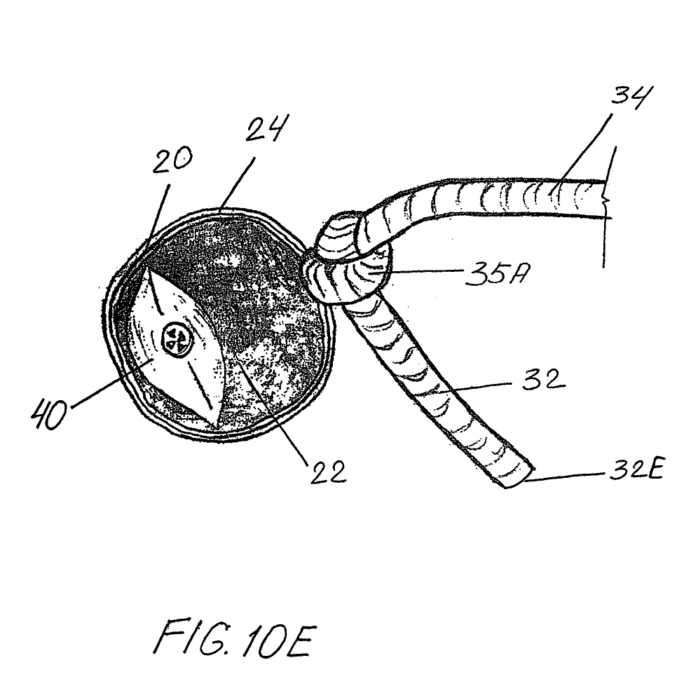

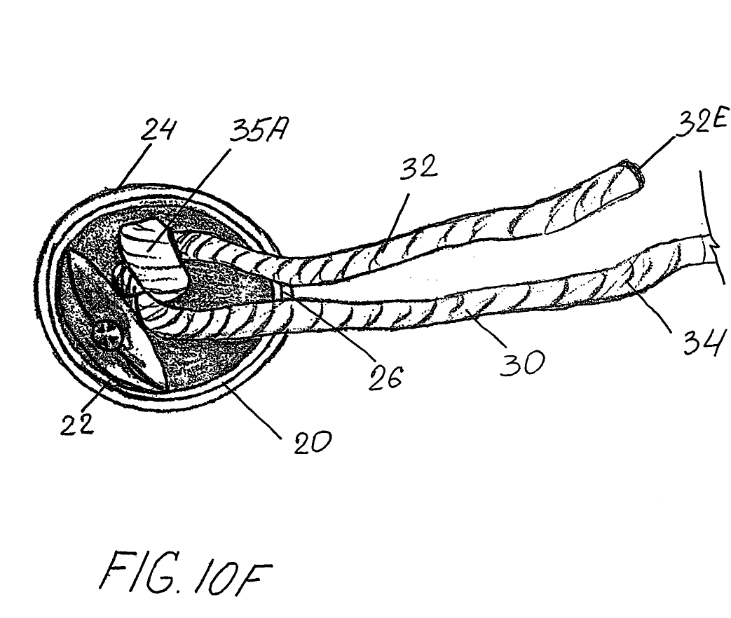

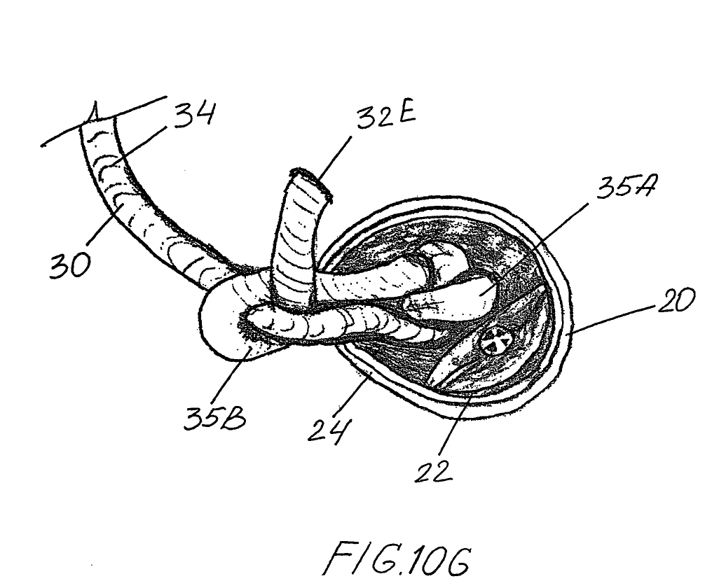

Dog tug toy 10 is manufactured by a unique method which allows a complex of knots of substantial size to be formed inside ball 20. That manufacturing method is preferably as follows: After rope opening 26 is drilled in ball 20 (see FIG. 10A) and squeaker device 40 is inserted into cavity 22 (see FIG. 10B), several knot-forming and stuffing steps are taken to create double knot 35 inside cavity 22 of ball 20. These steps are as follows: A first single knot 35A is tied in the entirety of rope 30 in first end portion 32 of rope 30 at a position approximately 6 inches from the end 32E of rope 30 (see FIG. 10C). (As used herein, the term “entirety of the rope” refers to whole cross-section of the rope, with all its strands together.) First single knot 35A is then pushed into interior cavity 22 through rope opening 26 leaving the remaining end of first end portion 32 outside ball 20 (see FIGS. 10D-10F). Then both free portions of rope 30 protruding from ball 20 are tied in their entirety into a second single knot 35B very close to outer surface 24 of ball 20 at rope opening 26 (see FIG. 10G). Next, both second single knot 35B and first end 32E of rope 30 are pushed into cavity 22 through rope opening 26.

The rope-ball attachment is then completed to form complex knot 35 within cavity 22 in the following manner: The single length of rope now protruding from ball 20 is manually pulled in a direction away from ball 20 while the puller grips ball 20 about rope opening 26 to prevent the not-yet-joined first and second single knots 35A and 35B from exiting the ball through rope opening 26. This causes the single knots to come together into double knot 35 (see FIG. 10H), which is significantly larger than either single knot—and, in fact, is large enough such that it cannot, for all practical purposes, be pulled out of ball 20. Thus, a rope-ball connection is formed which is highly strong and reliable and yet does not have an external knot of the sort which can cause dogs to gag when biting the ball.

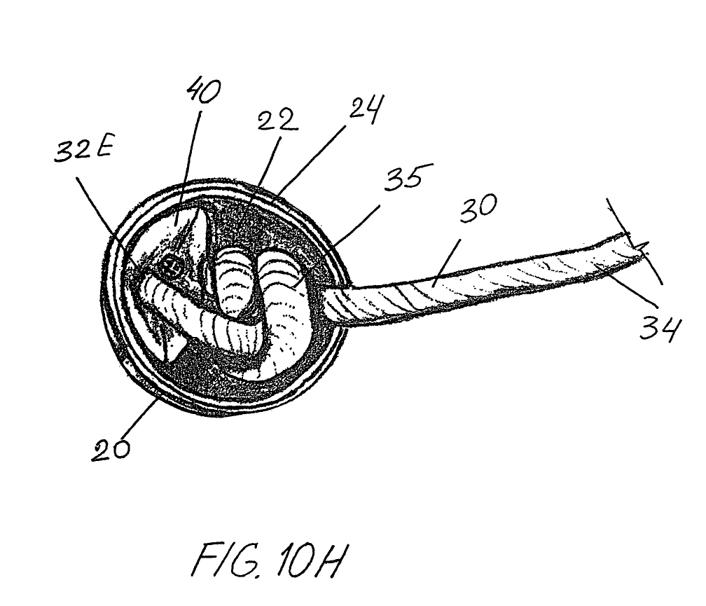

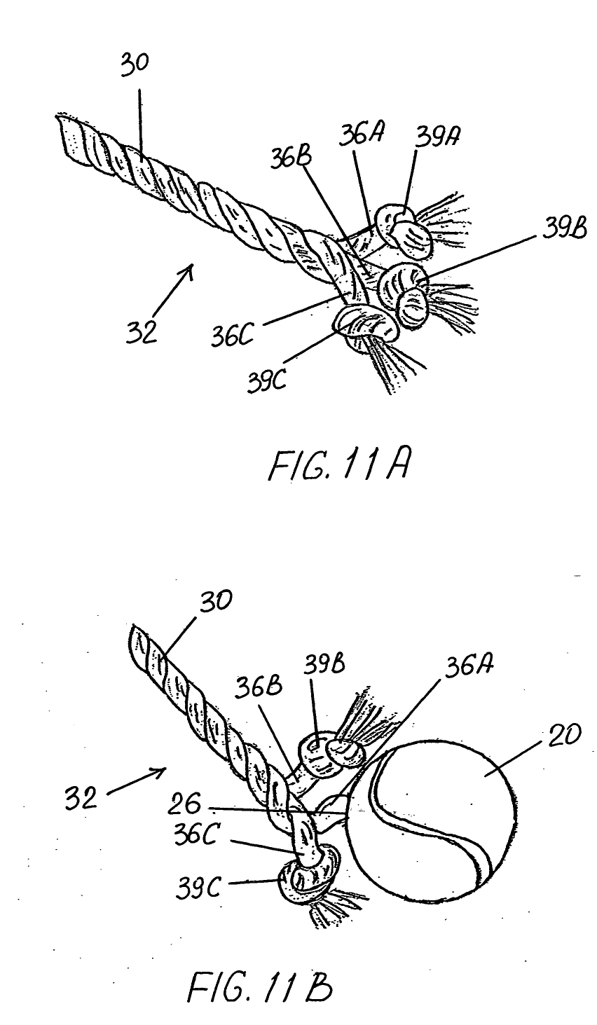

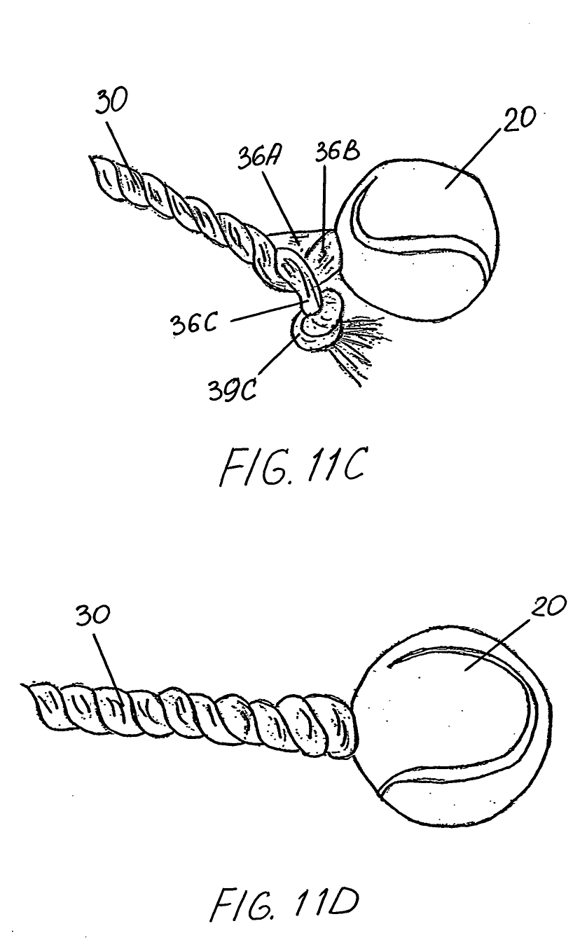

In an alternative embodiment of the method of manufacture of dog tug toy 10, rope 30 is formed by at least two strands 36, and a preliminary step is separating strands 36 in first end portion 32 of rope 30. The knots are tied in individual strands 36, such knots being positioned (in the tying thereof) substantially equidistant from end 32E of first end portion 32 of rope 30 (see FIG. 11A). The knot-forming and stuffing steps for this alternative embodiment are as follows: A first single knot 39A is tied in separated strand 36A. First single knot 39A is then pushed into interior cavity 22 through rope opening 26, along with the end of such strand, leaving separated strands 36B and 36C outside ball 20 (see FIG. 11B). A second single knot 39B is tied in separated strand 36B, which is outside ball 20, and pushed into ball 20 though rope opening 26. In the same way, a third single knot 39 C is tied in strand 36C and pushed into ball 20 thought rope opening 26. After single knots 39B and 39C pushed into ball 20 along with the respected strand ends, such single knots are adjacent to one another to form a complex of knots 39 inside ball 20 (see FIG. 11C-11D). Complex of knots 39 is of sufficient size such that rope 30 remains secured to ball 20, despite tugging force.

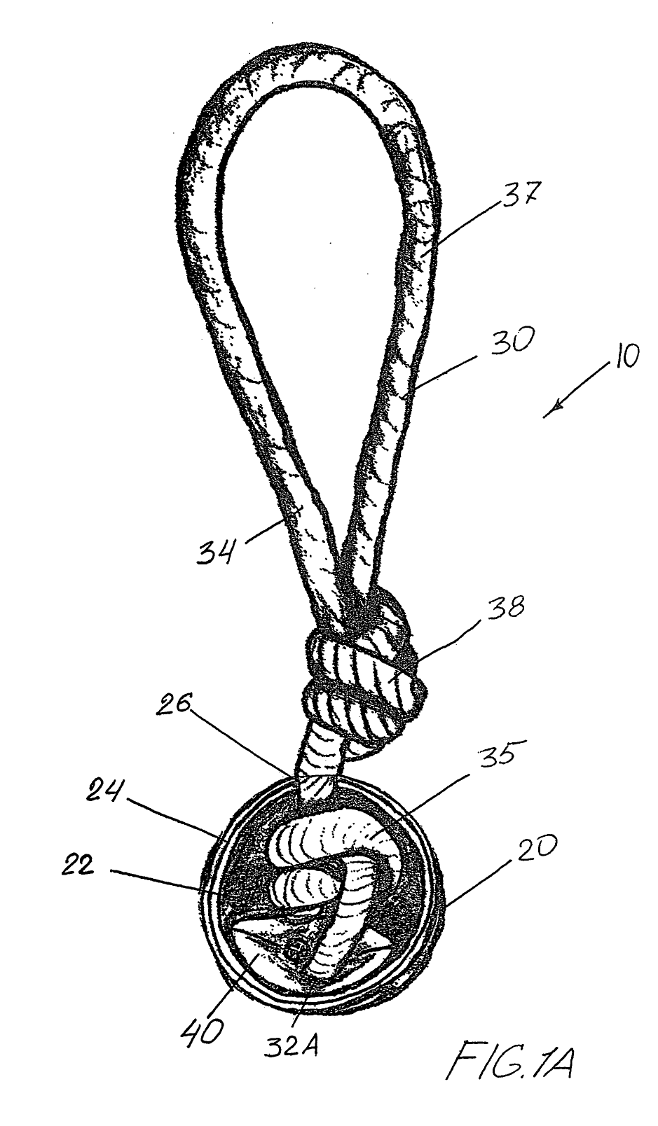

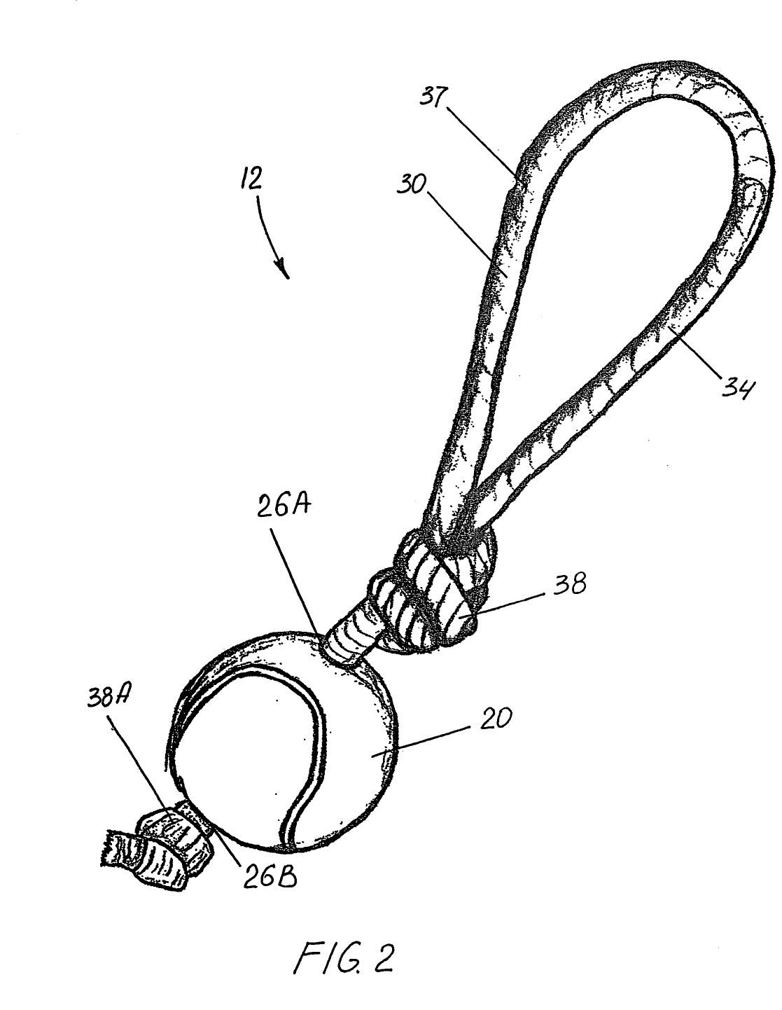

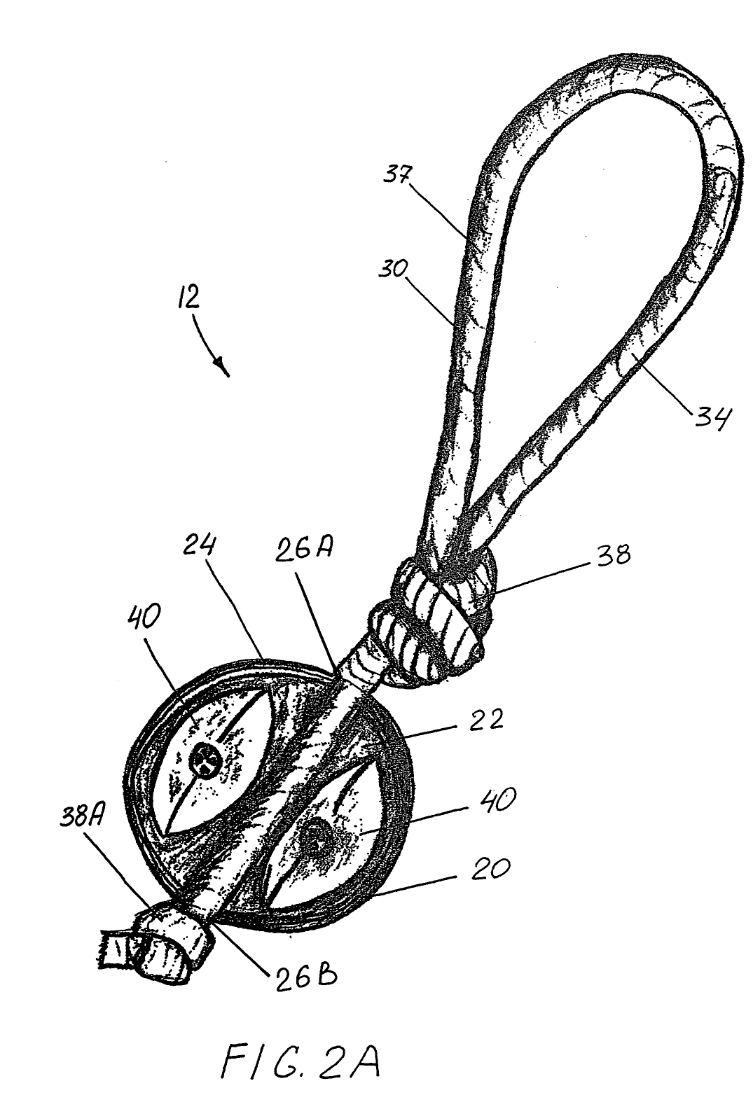

FIGS. 2 and 2A illustrate another embodiment of the squeaking dog tug toy of this invention, dog tug toy 12. In dog tug toy 12, rope 30 extends into cavity 22 of ball 20 through a first rope opening 26A and exits from the cavity 22 through a second rope opening 26B and is secured outside the ball 20 by a knot 38A. Two squeaker devices 40 are inserted into hollow interior cavity 22 of ball 20.

A squeaker device 40, known the prior art, is illustrated on FIGS. 5 and 5A. It includes a resilient air-containing bladder 46 which has an air tube 42 attached to it through which air is emitted when ball 20 is sufficiently squeezed in a dog's mouth to cause compression of bladder 46. Emission of air through air tube 42 causes a squeaking noise (whistle) which occurs inside ball 20 but is emitted through rope opening 26 in the ball. Release of the dog's grip allows resilient bladder to return to its non-compressed shape, ready for further squeezing and squeaking.

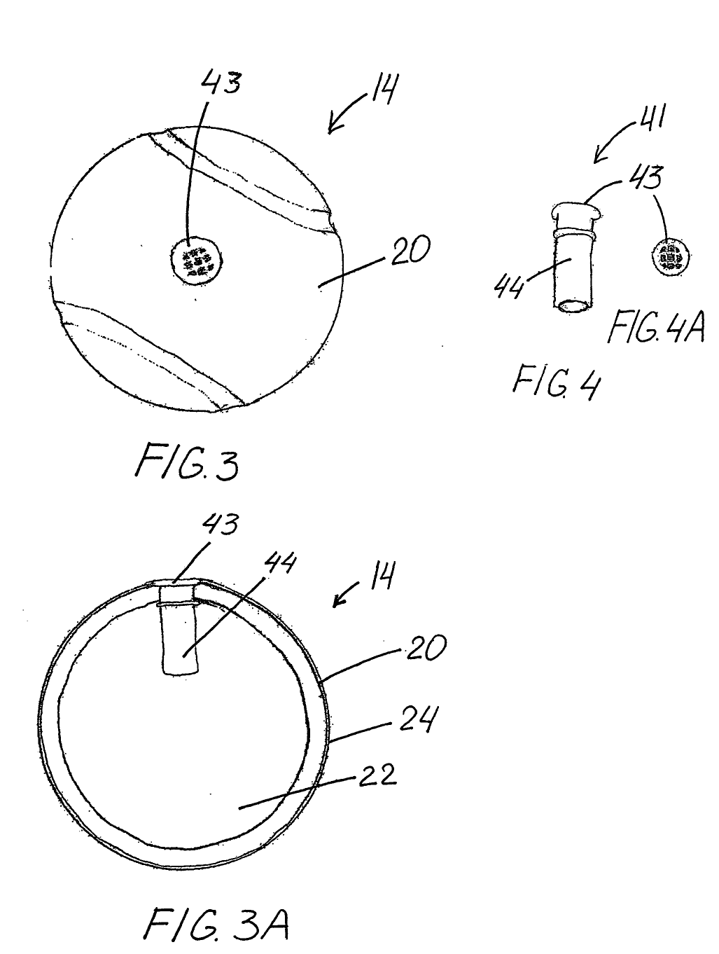

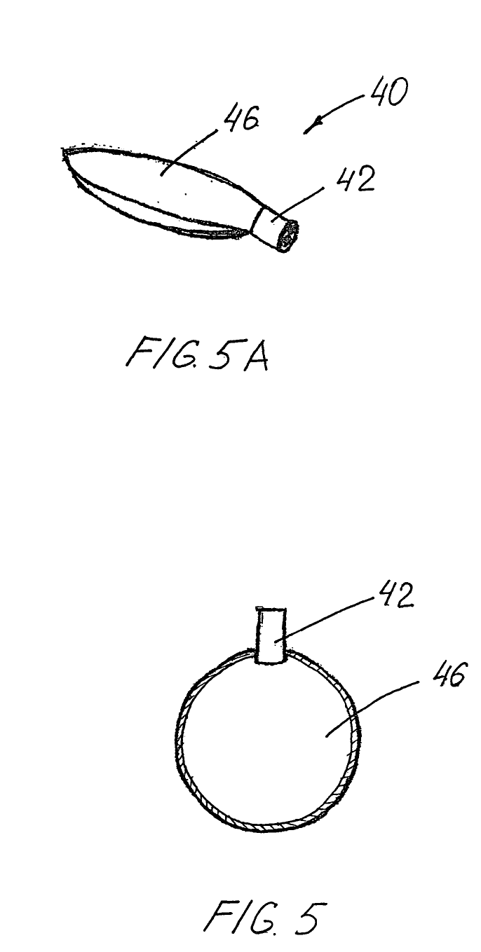

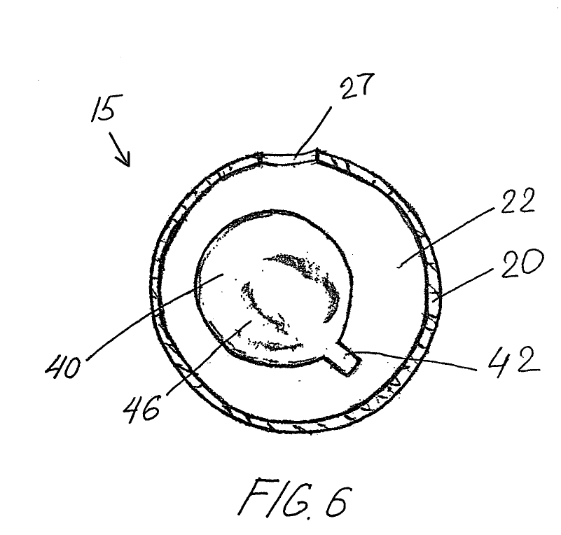

FIGS. 3 and 3A illustrate a unique dog ball toy 14 in accordance with this invention and FIG. 6 illustrates another dog ball toy 15 in accordance with this invention. Dog ball toys 14 and 15 each include a tennis ball 20 and include squeaker devices 41 and 40, respectively. In each case, tennis ball 20 has a hollow interior cavity 22 and a tough felt outer surface 24, and defines an opening 27. Squeaker device 41 of dog ball toy 14 is an air tube 42 the distal end 43 of which is flush with the outer surface 24 of ball 20. Squeaker device 40 of dog ball toy 15 is entirely within cavity 22 of the ball, and includes a resilient air-containing bladder 46 having a tube 42 attached thereto. Squeaker device 40 of dog ball toy 15 operates in the same manner as squeaker device 40 of dog tug toys 10 and 12, described above.

Squeaker tube 41, known the prior art, is illustrated more specifically in FIGS. 4 and 4A. It includes distal end 43 for flush mounting with the outer surface of ball and a proximal end 45 for location inside the ball.

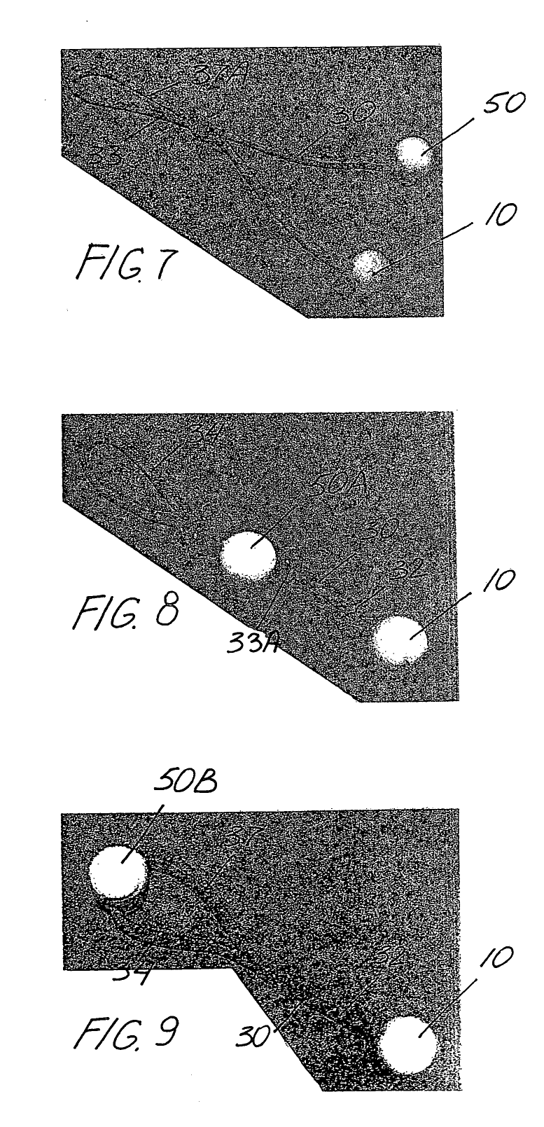

FIGS. 7-9 illustrate other embodiments of the squeaking dog tug toy of this invention, each including at least one rope-ball connection which is of the type described above. Each such embodiment includes a second ball. These embodiments are designed to suit the preferences of dog owners with respect to the particular form of a dog tug toy.

Referring to FIG. 7, a second ball 50 is attached to the end of second end portion 34 of rope 30 in the same attachment manner as used for first ball 20 in dog tug toy 10. The mid-portion 33 of rope 30, between first end portion 32 and second end portion 34, is tied into a loop 37A to form a handle.

Referring to FIG. 8, a second ball 50A is secured on mid-portion 33 of rope 30 between ball 20 (on first end portion 32) and a handle loop formed in second end portion 34. Mid-portion 33 of rope 30 passes through two opposed rope openings in second ball 50A. A knot 33A is tied in mid-portion 33 of rope 30 to maintain second ball 50A in place.

Referring to FIG. 9, a secondary ball 50B is secured on handle loop 37, by portion of such loop passing through two opposed rope openings in ball 50B.

Many other variations within the scope of the invention are possible. Many choices will be available to those skilled in the art who are made aware of the nature of this invention.

While the principles of the invention have been shown and described in connection with specific embodiments, it is to be understood that such embodiments are by way of example and are not limiting.

1. In a dog tug toy of the type including a biting object for a dog to bite attached to a rope to be held by a person, the improvement comprising:
the biting object having a hollow interior cavity and a tough outer surface defining at least one rope opening into the cavity;
at least one squeaker device within the cavity;
the rope having a first end portion extending into the cavity through the rope opening.

2. The dog tug toy of claim 1 wherein the biting object has a tennis-ball-like outer surface.

3. The dog tug toy of claim 2 wherein the biting object is a tennis ball.

4. The dog tug toy of claim 2 wherein the squeaker device is entirely within the cavity.

5. The dog tug toy of claim 2 wherein there are two squeaker devices within the cavity.

6. The dog tug toy of claim 1 wherein the rope includes a second end portion forming a handle.

7. The dog tug toy of claim 6 wherein the handle includes a loop formed in the second end portion.

8. The dog tug toy of claim 7 wherein an additional biting object is secured to the handle loop.

9. The dog tug toy of claim 8 further including at least one squeaker device in the additional biting object.

10. The dog tug toy of claim 7 wherein the rope has a mid-portion between the first and second end portions, the mid-portion having yet another biting object secured thereto.

11. The dog tug toy of claim 10 further including at least one squeaker device in the biting object secured to the mid-portion.

12. A dog toy comprising:
a tennis-ball-like ball having a hollow interior cavity and a tough outer surface; and
at least one squeaker device within the cavity.

13. The dog ball toy of claim 12 wherein the ball is a tennis ball.

14. The dog ball toy of claim 13 wherein the squeaker device includes a squeaker tube having a distal end substantially flush with the outer surface of the ball.

15. The dog ball toy of claim 13 wherein the squeaker device is entirely enclosed within the cavity.

16. The dog ball toy of claim 13 wherein there are two squeaker devices within the cavity.

17. A dog toy for biting by dogs comprising:
a resilient body having a hollow interior cavity and a tough outer tennis-ball-like surface; and
at least one squeaker device within the cavity.
